(19) United States
(12) Patent Application Publication
(10) Pub. No.: US 2017/0270531 A1
(43) Pub. Date: Sep. 21, 2017

(54) ACCOUNT NOTIFICATIONS FOR REQUIRED INFORMATION TO COMPLETE A FINANCIAL TRANSACTION

(71) Applicant: PAYPAL, INC., San Jose, CA (US)

(72) Inventor: Hyunju Lee, Singapore (SG)

(21) Appl. No.: 15/612,951

(22) Filed: Jun. 2, 2017

Related U.S. Application Data
(63) Continuation of application No. 14/270,772, filed on May 6, 2014.
(60) Provisional application No. 61/890,982, filed on Oct. 15, 2013.

(51) Int. Cl. G06Q 20/42; G06Q 20/40

(52) U.S. Cl. CPC G06Q 20/42; G06Q 20/405; G06Q 20/401

(57) ABSTRACT

There is provided systems and method for account notifications for required information to complete a financial transaction. A user may establish a user account with a payment provider, where the user account allows the user to receive and transfer funds with other users. The payment provider may require additional information from the user to validate and maintain the user account or to complete monetary transfers. Thus, the payment provider may prepare notifications for the user and transmit the notifications to a user device of the user. The user may provide user input through the user device to complete the notification, where in some cases the user input corresponds to an image from the user. The payment provider may transmit an edit tool to redact information from the image if necessary. The user may request a hold on funds in the user account, or may authorize transactions.

### CROSS-REFERENCE TO RELATED APPLICATIONS

This application is a continuation of U.S. patent application Ser. No. 14/270,772 filed May 6, 2014, which claims benefit of priority from U.S. Provisional Patent Application No. 61/890,982, filed Oct. 15, 2013, both of which are incorporated by reference in their entirety.

### TECHNICAL FIELD

Example embodiments of the present application relate generally to account notifications for required information to complete a financial transaction and more specifically to providing account notifications to a user through a user device, where the account notifications include requests for user information and/or account activity alerts.

### BACKGROUND

Users may establish user accounts with different types of service providers. One type of service provider may be a payment provider that offers financial services to users, including fund transfers, withdrawals, payments, and/or account maintenance. However, without proper user personal and/or financial information, the payment provider may be unable to complete the financial transactions. While the payment provider may request the information on establishment of the account, or when a user logs in to an account, the information may change over time, or additional information may be requested in the future. The payment provider may also require authorization for financial transactions or wish to alert the user of account activity. If the service provider waits until the user accesses the user account, a time period for verifying the financial transaction may expire or a detrimental transaction may be posted to the user account. For example, a financial transaction may request a large monetary amount from a user account. However, without proper approval, the service provider may abstain from completing the transaction due to its potentially unauthorized nature. Thus, a user may not receive approval for payment of an item, or may incur late payment penalties.

### BRIEF DESCRIPTION OF THE DRAWINGS

FIG. 1 is a block diagram of a networked system suitable for implementing the process described herein, according to an embodiment;

FIG. 2A is an exemplary environment having a user device displaying account notifications received from a payment provider, according to an embodiment;

FIG. 2B is an exemplary environment having a user device utilized to complete account notifications received from a payment provider, according to an embodiment;

FIG. 3A is an exemplary user device displaying user information utilized to complete a request for user information in an account notification, according to an embodiment;

FIG. 3B is an exemplary user device submitting redacted user information utilized to complete a request for user information in an account notification, according to an embodiment;

FIG. 4 is a flowchart of an exemplary process for account notifications for required information to complete a financial transaction, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for account notifications for required information to complete a financial transaction. Systems suitable for practicing methods of the present disclosure are also provided.

A user may establish a user account with a payment provider, where the user account allows the user to receive and transfer funds with other users, complete payment to merchants or users selling items, and/or provide other financial services, including banking and credit services. When establishing the account, the user may provide personal and/or financial information to the payment provider to create the account. Additionally, the information may include sufficient details for monetary transfers between parties. During the course of use of the account, the user may transfer funds, request a withdrawal of funds, complete large payments with merchants, and/or engage in another transaction using the payment provider. The user may do so without accessing the payment provider directly. For example, the user may identify the payment provider and the user's account with the payment provider to a third party for payment and/or transfer completions. In other embodiments, the user may utilize a user device application corresponding to the payment provider to engage in a financial transaction, for example, an application for a smart phone operating system.

Thus, the payment provider may require additional information from the user to validate and maintain the user account and/or to complete monetary transfers. For example, the user may receive a large deposit from another user. In order to hold the funds and/or allow for withdrawal, the payment provider may require personal information to verify the user is the correct receiver of the funds. The payment provider may further require information for another financial account, such as a checking account with which to transfer the funds, or may require personal information for a mailed check or payment card. In other embodiments, the payment provider may wish to provide a notification to the user of account activity and advise the user of potential adverse actions taken with regard to the user's account. In such embodiments, the payment provider may wish to prevent these adverse actions through further information submissions.

Thus, the payment provider may prepare account notifications for the user and transmit the account notifications to a user device of the user. The notifications may to withdrawn funds in the user account, and/or an alert corresponding to an amount of funds in the user account. The account notifications may populate in a device application on the user device. Additionally, the account notifications may populate in the background of an operating system of the user device, as banners or alerts on a home screen, lock screen, or toolbar of the user device, or elsewhere that may catch the attention of the user. The account notifications may display why the information is required. The account notifications may further display what information is required and what steps to take in order to complete the account notifications. Moreover, the potential adverse effects and when they might occur may be displayed in the account notifications. For example, a deadline for submission of user information may be displayed with a notice that transferred funds will be returned if the user information is not submitted. In various embodiments, the payment provider may identify a case level/importance for the account notification, which may be transmitted to the user device and/or used for internal processing of the account notification.

The user may provide user input through the user device to complete the account notification. For example, if the account notification includes a request to submit user personal information, the user may provide a name, address, phone number, or other required personal information to complete the account notification. Thus, the payment provider may complete the request for information using the user input. Additionally, the payment provider may transmit a completion update to the user device, showing required additional information from the user, and, in various embodiments, a completion percentage/bar/etc. corresponding to a completion amount of the request for information. Once the user has completed all or part of the request for information, a status update may be posted next to the account notification that includes an expected time to verification that the user has completed the account notification.

The user input may correspond to an image, for example, a bank statement, social security card, driver license, birth certificate, passport, or other valid identification. A payment provider application on the user device of the user may supply an edit interface having edit tools for use with the image. The edit tools may allow for resizing, cropping, etc. The edit tools may further enable redaction of information from the image if necessary. For example, the user may transmit a copy of a bank statement to the payment provider for proof of ownership of the account and the account number. However, the user may wish to redact purchases in a purchase history visible on the bank statement. Thus, the redaction tool may provide for blacking out of the purchase history. In other embodiments, the user may request a hold on funds in the user account, or may authorize transfers, withdrawals, or other financial transactions. Additionally, the payment provider application may provide for generating and completing an authorization letter, including text input, a signature block, and/or an option to forward the letter to an authorizing person or entity required to complete the authorization letter.

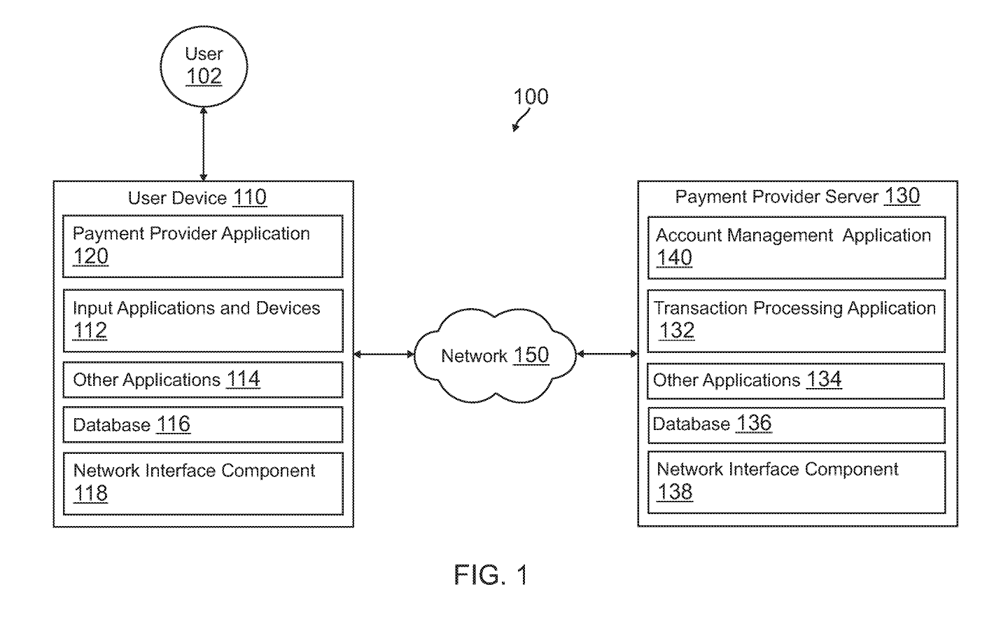

FIG. 1 is a block diagram of a networked system 100 suitable for implementing the process described herein according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, and a payment provider server 130 in communication over a network 150. User 102 may utilize user device 110 to establish and maintain a user account with payment provider server 130. Payment provider server 130 may transmit account notifications to user device 110 and complete the account notifications with user input provided by the user.

User device 110 and payment provider server 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

User device 110 may be implemented using any appropriate hardware and software configured for wired and/or wireless communication between user device 110 and payment provider server 130. For example, in one embodiment, user device 110/120 may be implemented as a personal computer (PC), a smart phone, laptop computer, wristwatch with appropriate computer hardware resources, eyeglasses with appropriate computer hardware (e.g. GOGGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may function similarly.

User device 110 of FIG. 1 contains a payment provider application 120, input applications and devices 112, other applications 114, a database 116, and a network interface component 118. Payment provider application 120, input applications and devices 112, and other applications 114 may correspond to processes, procedures, and/or applications executable by a hardware processor, for example, a software program. In other embodiments, user device 110 may include additional or different software as required.

User device 110 includes payment provider application 120, which may be configured to provide a convenient interface to permit a user to engage in financial transactions, view account notifications, provide user input to complete the account notifications, and check the status of completion of the account notifications. Thus, payment provider application 120 may access network 150 to communicate with payment provider server 130, for example through accessing the Internet. Payment provider application 120 may correspond to a dedicated application of payment provider server 130, such as an application offered by payment provider server 130 that may provide services corresponding to payment provider server 130. Thus, payment provider application 120 may be configured to transmit and receive data over network 150, such as data including account notification, webpages, etc. Additionally, payment provider application 120 may transmit user input to payment provider server 130. In certain embodiments, payment provider application 120 may be implemented as or include features of a web browser configured to view information available over the Internet, for example, accessing a website, and receive information from the website. However, if payment provider application 120 solely requires a user to navigate to a website of payment provider server 130 to receive data, payment provider application 120 may not provide notifications to user 102 absent user 102 navigating to payment provider server 130 and accessing a user account. Thus, payment provider application 120 may include features to receive data with or without accessing payment provider server 130, for example, through e-mail, SMS/MMS messaging, etc.

Payment provider application 120 may receive a request to establish an account with payment provider server 130. In this regard, payment provider application 120 may provide an interface allowing user 102 to first establish a user account with payment provider server 130. Additionally, payment provider application 120 may retain and/or access account information (e.g., account login) to maintain account access on user device 110. Payment provider application 120 may receive account notifications generated by payment provider server 130, as will be discussed in more detail herein. After receiving the account notifications, payment provider application 120 may present the notifications to user 102. Account notifications may be presented as an alert, such as a message, highlight, toolbar notice, application badge, or other means to notify user 102 an account notification is awaiting review. User 102 may view an interface on user device 110 to select the account notifications in order to complete the account notification. For example, selection of an account notification may cause payment provider application 120 to display information for the account notification. The information may include why the account notification is occurring (e.g., what cause the account notification), a deadline for completion of the account notification, tasks to complete the account notification, completion status of the account notification, and/or a review status of the account notification. Other information may also be displayed on selection of the account notification.

Further, after selection of the account notification, payment provider application 120 may receive user input corresponding to account notification. For example, user 102 may input information to payment provider application 120 to complete the account notification. Where notifications correspond to one or more requests for personal and/or financial information, the user may transmit information enabling payment provider server 130 to complete the request(s) for information and update the user account. Thus, payment provider application 120 may provide for text, voice, and/or image input by user 102. The text, voice, and/or image input may be transmitted to payment provider server 130 for completion of the account notification. In certain embodiments, the user input may not be utilized to complete the account notification but may instead correspond to another action taken with respect to the user account with payment provider server 130. For example, user 102 may view an account notification that includes a request for verification of identity before a large withdrawal is made. Instead of submitting identification to payment provider server 130, user 102 may wish to view the withdrawals information and/or place a hold on the user account if the withdrawal is suspicious.

If user 102 wishes or is required to submit an image to complete the request for information, user 102 may utilize payment provider application 120 to capture an image, or may import an image to payment provider application 120 from another application or database. Payment provider application 120 may provide edit tools in an application interface for use with the image. Edit tools may enable user 102 to resize, crop, rotate, change color/contrast, and/or otherwise alter the image. The edit tools may be presented in an edit interface of payment provider application 120, where the interface may display the image with the edit tools. In various embodiments, the edit tools may further include a sensitive information redaction tool that may enable user 102 to redact or otherwise omit information present in an image. Thus, the redaction tool may enable user 102 to black/white out sections or delete text/images/graphics/etc. from the image. The edit tools may further allow user 102 to add text to an image, combine multiple images, or otherwise add/delete information from an image.

Payment provider application 120 may further provide forms or text boxes that user 102 may utilize to generate consent and/or authorizations letters. The consent/authorization letters may be used in financial transactions to verify that a financial transaction is correct and authorized by a user. Thus, payment provider application 120 may provide stock letters, or may accept user text, voice, or other input to generate a letter. Payment provider application 120 may transmit the letter to payment provider server 130 for review and distribution as necessary.

During completion of one or more account notifications, user 102 may submit partial information to complete the account notification. For example, user 102 may provide personal information to payment provider server 130, but have yet to complete a financial information request. Thus, payment provider server 130 may supply user 102 with completion updates detailing additional information required by user 102 to complete the request for information. The completion updates may include a status bar display, for example, a completion percentage for the request for information.

Account notification in payment provider application 120 may include alerts about one or more payment/financial accounts and their corresponding funds. For example, an alert may correspond to an amount of funds in a user account (e.g. low funds or insufficient funds for a transaction) or may correspond to a transfer/withdrawal of funds in a user account (e.g. a transfer/withdrawal of a very large amount or in a suspicious location). Thus, payment provider application 120 may receive user input in response corresponding to a request for a hold or freeze the payment account or an authorization to withdraw/transfer the monetary amount.

Once payment provider application 120 has transmitted input by user 102 to payment provider server 130, payment provider application 120 may receive a status update that informs user 102 of the status of the information submission. For example, if user 102 transmits a driver license image to payment provider server 130 for processing to verify the identity of user 102, payment provider server 130 may require some amount of time to process and verify the image. Thus, payment provider server 130 may transmit status updates with an expected time to verify user 102 has completed the request for information in the account notification, results of the submission (e.g., if it was successful and/or verified), account actions taken while the results are pending, and/or a status of the financial transaction that caused the account notification.

In various embodiments, payment provider application 120 may include payment and/or financial transaction processing features. In this regard, payment provider application 120 may include an interface to permit user 102 to select payment/transfer options and provide payment for items (e.g. goods and/or services) or arrange a transfer with another entity. For example, payment provider application 120 may be implemented as an application having a user interface enabling the user to enter financial account information (e.g., payment card, bank account, etc.) for storage by user device 110 and complete a transaction using the financial account information. Payment provider application 120 may utilize user financial information, such as a credit card, bank account, or other financial account. Additionally, payment provider application 120 may provide payments/transfers using a user account with payment provider server 130.

Input applications and devices 112 may include applications and/or devices of user device 110 that may be utilized to provide user input to complete account notifications. In various embodiments, input applications and devices 112 may include mouse, keyboard, touchpad, touchscreen, camera, microphone, GPS, compass, or other input applications and/or devices. Input applications and devices 112 may be utilized in conjunction with payment provider application 120 to receive input corresponding to account notifications for transmission to payment provider server 130. Thus, input applications and device 112 may include a camera device and matching application for capturing images used to complete requests for information. In other embodiments, the camera device may be utilized by payment provider application 120. In various embodiments, input applications and devices may include voice recognition and processing applications to determine data from voice input by user 102.

In various embodiments, payment provider application 120 and certain input applications of input applications and devices 112 may be incorporated in the same application so as to provide their respective features in one convenient application interface.

User device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 150, or other types of applications. Other applications 114 may also include email, texting, voice and instant messaging applications that allow a user to send and receive emails, calls, texts, and other notifications through network 150. In various embodiments, other applications 114 may include financial applications, such as banking, online payments, money transfer, or other applications associated with payment provider server 130. Additionally, other application 114 may include social networking/media applications, including microblogging applications. Other applications 114 may contain other software programs, executable by a processor, including a graphical user interface (GUI) configured to provide an interface to the user.

User device 110 may further include database 116 which may include, for example, identifiers such as operating system registry entries, cookies associated with payment provider application 120, input applications and devices 112, and/or other applications 114, identifiers associated with hardware of user device 110, or other appropriate identifiers, such as identifiers used for payment/user/device authentication or identification. In one embodiment, identifiers in database 116 may be used by a merchant device and/or payment provider, such as payment provider server 130, to associate user 102 and/or user device 110 with a particular account maintained by the payment/credit provider. Database 116 may include user personal and/or financial information, images captured by user device 110, and/or other information for transmission to payment provider server 130. Account notifications received from payment provider server 130 may be stored to database 116 so that the account notifications are accessible even in an offline mode of user device 110. In various embodiments, database 116 may further include user account access information. Thus, database 116 may include user personal information (e.g. a name, social security number, user financial information, or other identifying information), a user account identifier, and/or a user account login name/password. Database 116 may include transaction histories stored for later use, where transaction histories may be generated from purchases/transfers using payment provider application 120.

In various embodiments, user device 110 includes at least one network interface component 118 adapted to communicate with payment provider server 130 over network 150. Thus, network interface component 118 may include a DSL (e.g., Digital Subscriber Line) modem, a PSTN (Public Switched Telephone Network) modem, an Ethernet device, a broadband device, a satellite device and/or various other types of direct wired and/or wireless network communication devices including microwave, radio frequency (RF), and infrared (IR) communication devices. In various embodiments, network interface component 118 may include a communication module for short range communications including microwave, radio frequency, infrared, Bluetooth, and near field communication devices.

Payment provider server 130 may be maintained, for example, by an online payment service provider, which may provide payment and account notification services to a user. In this regard, payment provider server 130 includes one or more processing applications configured to determine notifications corresponding to a user account of user 102 and transmit the notification to user device 110. In one example, payment provider server 130 may be provided by PAYPAL®, Inc. of San Jose, Calif., USA. However, in other embodiments, payment provider server 130 may be maintained by or include a merchant, financial services provider, and/or other service provider, which may provide account services to user 102. For example, account notification features may be provided by EBAY®, Inc. of San Jose, Calif., USA.

Payment provider server 130 of FIG. 1 includes an account management application 140, a transaction processing application 132, other applications 134, a database 136, and a network interface component 138. Account management application 140, transaction processing application 132, and other applications 134 may correspond to processes, procedures, and/or applications executable by a hardware processor, for example, a software program. In other embodiments, payment provider server 130 may include additional or different software as required.

Account management application 140 may include processes and procedures to enable user 102 to establish and maintain a user account with payment provider server 130 and provide account notifications to user 102 based on the user account. In this regard, account management application 140 may receive information from user 102 to establish a user account, as previously discussed. The information provided to establish the user account may include personal, financial, or other information. However, in certain embodiments, user 102 may provide only minimal information to establish the user account. Thus, after establishment of the user account and/or after an action occurring with respect to the account (e.g., a withdrawal, deposit, transfer, payment, etc.), payment provider server 130 may require additional information from user 102 in order to complete the action.

Account management application 140 may include a risk and compliance model that processes and validates actions taken by user 102 with respect to the established user account of user 102. For example, user 102 may request transfers, withdrawals, deposits, etc. Based on the risk of the transaction, the risk and compliance model may request additional information from user 102 to validate the account and activities. For example, if the transfer, withdrawal, and/or deposit is a large sum of money, requested from an unknown user device or login area, or if the IP address of the user device is far from user 102's normal area, account management application 140 may determine that additional information is required to validate the activity and authorize the transaction. Thus, when further validation is necessary, the risk and compliance model may determine an account notification should be pushed to user device 110 that requests user 102 provide a proof of identity.

Thus, account management application 140 may determine one or more account notifications corresponding to the user account in order to maintain the user account. Account management application 140 may determine the one or more notifications by determining if a financial transaction and/or account alert requires additional personal and/or financial information, proof of identity, and/or an authorization/consent for a financial transaction. Thus, the account notification may include a request for personal information, a request for financial information, a request for proof of identity, and/or a request for an authorization/consent to a financial transaction or an authorization/consent letter. The account notification may include information about why the account notification was generated (e.g., what financial transaction or account alert caused the account notification), steps to complete the account notification, a time to complete the account notification, and adverse account actions of effects that may occur if the account notification is not completed. Additionally, in certain embodiments, the account notification may include an alert corresponding to withdrawn funds in the user account, an alert corresponding to a purchase or transfer of funds in the user account, and/or an alert corresponding to an amount of funds in the user account (e.g., a low balance warning). The notification(s) may be transmitted to user device 110 for presentation to user 102, as previously discussed.

Account management application 140 may receive user input corresponding to the notification from user device 110. The user input may come in the form of text input, voice input, and/or an image. Account management application 140 may therefore include text, voice, and/or image processing processes, or a system administrator of payment provider server 140 may review the input. In certain embodiments, account management application 140 may provide user device 110 with image editing tools, word processing features, and/or electronic signature features for use in image inputs and/or authorization/consent letters.

Thus, account management application 140 may process the user input to determine if the user input partially or completely fulfills a request in the account notification. During processing of the user input, account management application 140 may provide user 102 with status updates displaying a status for resolution of the account notification using the user input and/or an expected time to completion of processing the user input. If the input does not complete the request(s) in the account notification, account management application 140 may alert user 102 through payment provider application 120 that the input was not accepted and additional input may be required. In other embodiments, the user input may correspond to a freeze on an account, a request to cancel and/or utilize fraud protection for a transaction, or other account action. In such embodiments, account management application 140 may perform the requested action on the user account of user 102.

Where the account notification corresponds to a request for information, account management application 140 may complete the request for information using the user input if the user input corresponds to information submissions, as previously discussed. Thus, if the information submission in the user input is sufficient to resolve all or part of the request for information in the account notification, account management application 140 may begin resolving the account notification. If the information completely resolves the account notification, user 102 may be alerted through payment provider application 120. However, if additional information is required, account management application 140 may transmit a completion update to user device 110 detailing additional required information from user 102. The completion update may include requested information and/or a status percentage.

Transaction processing application 132 may be configured to receive information from user device 110 for processing and completion of financial transactions. Transaction processing application 132 may receive a payment request to complete a sale transaction for an item and/or service. Additionally, transaction processing application 132 may receive transfer requests, deposits, and/or withdrawal requests. Transaction processing application 132 may receive a user account for user 102 with payment provider server 130 and another account for a merchant, user, or other entity involved in the financial transaction. In other embodiments, transaction processing application 132 may receive user financial information, such as a payment card, bank account, gift card, or other financial information. In certain embodiments, transaction processing application 132 may provide transaction histories, including receipts, to user device 110 in order to provide proof or purchase and complete the financial transaction.

In various embodiments, payment provider server 130 includes other applications 134 as may be desired in particular embodiments to provide features to payment provider server 130. For example, other applications 134 may include security applications for implementing server-side security features, programmatic server applications for interfacing with appropriate application programming interfaces (APIs) over network 150, or other types of applications. Other applications 134 may contain software programs, executable by a processor, including a graphical user interface (GUI), configured to provide an interface to a user.

Additionally, payment provider server 130 includes database 136. As previously discussed, user 102 may establish one or more user accounts with payment provider server 130. User accounts in database 136 may include user/merchant information, such as name, address, birthdate, payment/funding information, additional user financial information, and/or other user data. In various embodiments, user 102 may not have previously established a user account for payment services and may provide other financial information to payment provider server 130 to complete financial transactions, as previously discussed. Account notifications for user 102 and their corresponding requests for information and/or account alerts may be stored to database 136. Database 136 may further include information received from user 102, including user input (e.g., text data, voice data, and/or images), as previously discussed.

In various embodiments, payment provider server 130 includes at least one network interface component 138 adapted to communicate with user device 110 over network 150. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

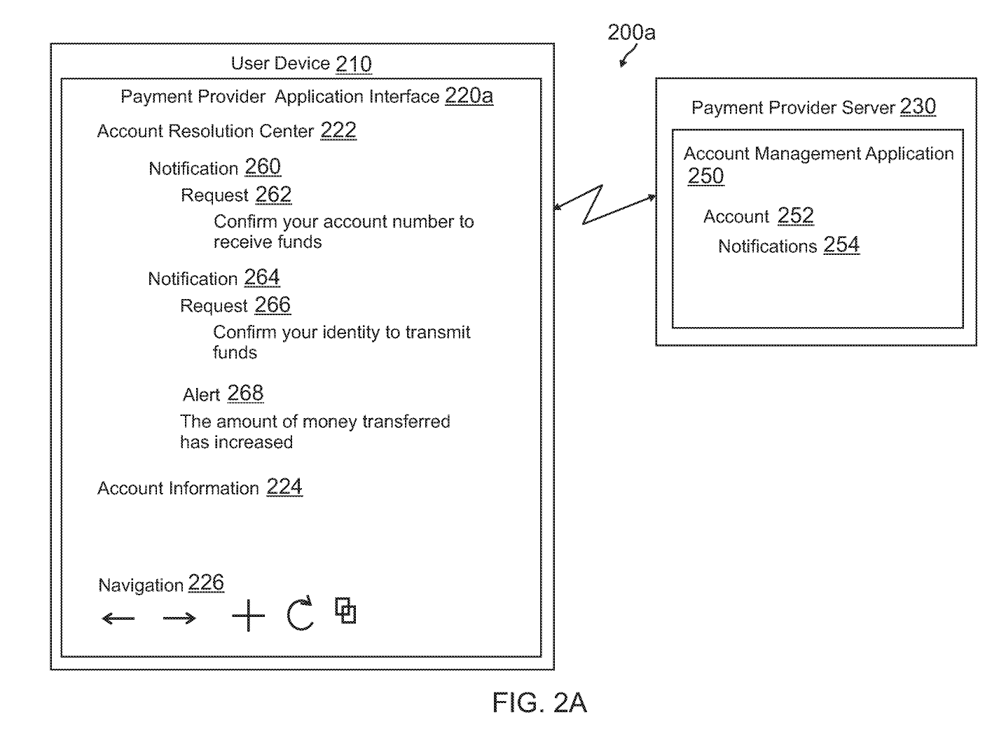

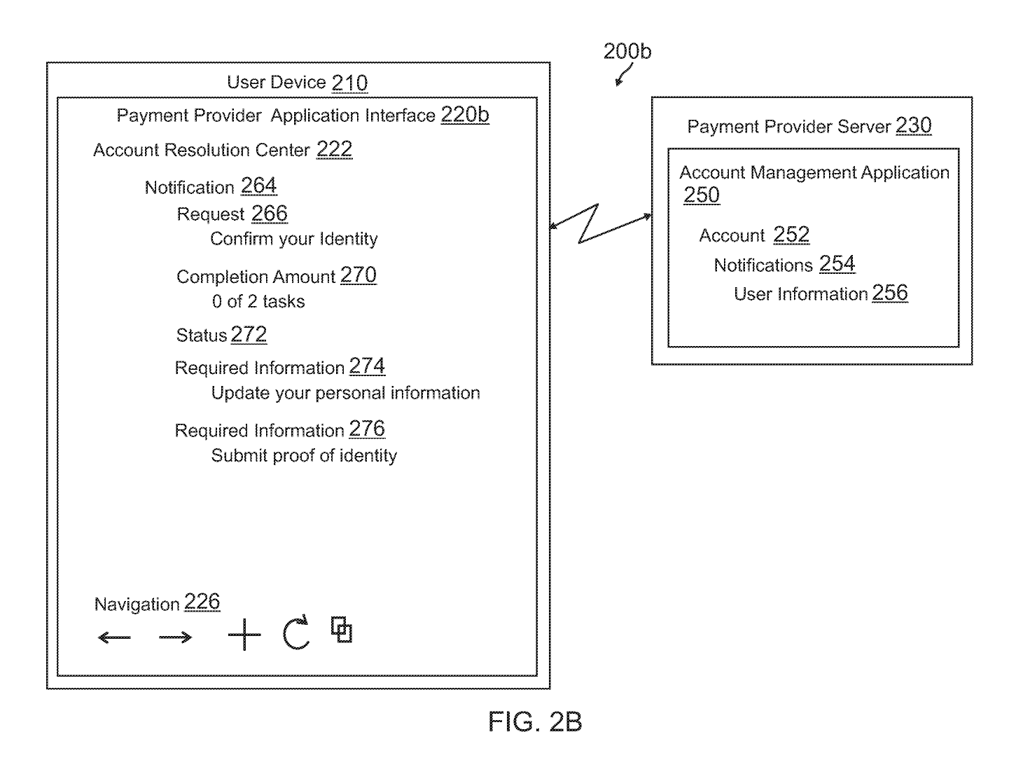

FIG. 2A is an exemplary environment having a user device displaying account notifications received from a payment provider, according to an embodiment. Environment 200a of FIG. 2A includes a user device 210 and a payment provider server 230 corresponding generally to user device 110 and payment provider server 130, respectively, of FIG. 1.

User device 210 of FIG. 2A displays a payment provider application interface 220a to a user (not shown) of user device 210. Payment provider application interface 220a may correspond to an interface displaying similar executed processes and procedures of payment provider application 120 of FIG. 1. In this regard, payment provider application interface 220a displays an account resolution center 222, account information 224, and navigation 226 to the user. Account resolution center 222 may display account notifications received from payment provider server 230 for resolution by the user.

Thus, payment provider server 230 includes an account management application 240, which may correspond generally to the processes and procedures of account management application 140 of FIG. 1. In this regard, account management application 240 may determine account notifications based on actions and/or financial transactions involving a user account for the user of user device 210. Account management application 240 includes an account 252 corresponding to a user account held by the user. As previously discussed, account 252 may correspond to a payment or other financial account that the user may utilize to perform payments, transfers, withdrawals, deposits, or other transactions involving available funds with account 252. Based on these transactions, account management application 240 may determine notifications 254, which may correspond to account notifications. Notifications 254 may include requests for user information from the user of user device 210, as well as alerts based on the transactions for account 252. Once account management application 250 has determined notifications 254, notifications 254 may be transmitted to user device 210 for display to the user through payment provider application interface 220a.

After receiving notifications 254, user device 210 may display notifications 254 in account resolution center 222 of payment provider application interface 220a. Account resolution center 222 includes a notification 260, a notification 264, and an alert 268. Notifications 260 may display an account notification to the user of user device 210 along with request 262. As previously discussed, notification 260 may include a warning to the user that without completing request 262, an action may be taken with respect to account 252. The action may be an adverse account action or a reversal of an account action. Thus, notification 260 may display why notification 260 is populating, a time to complete notification 260, and potential adverse account actions resulting in a failure to complete notification 260. Notification 264 may display similar information.

Request 262 of notification 260 include a request for user information. Thus, request 262 populates the text “Confirm your account number to receive funds.” Request 266 also corresponds to a request for user information and displays “Confirm your identity to transmit funds.” By selection of notification 260 or notification 264 (or their respective requests 262/266), the user of user device 210 may begin entering user input to complete notification 260/264 and/or take another account action, as will be discussed in reference to FIG. 2B. Thus, payment provider application interface 220a may provide for navigation features to enable the user to view and complete account notifications. The user may further use navigation 226 to navigate through the account notifications and other features of payment provider application interface 220a.

Payment provider application interface 220a includes alert 268, which may display an account alert with respect to account 252. In various embodiments, alert 268 may be incorporated in notification 260 and/or notification 264 that caused payment provider server 230 to generate alert 268. Alert 268 displays to the user of user device 210 that “The amount of money transferred has increased.” Thus, alert 268 informs the user of the actions of account 252 to prevent fraudulent and/or incorrect account transactions. Payment provider application interface 220a may further include account information 224 so that the user may view information for and/or switch user accounts with payment provider server 230.

FIG. 2B is an exemplary environment having a user device utilized to complete account notifications received from a payment provider, according to an embodiment. Environment 200b of FIG. 2B includes a user device 210 and a payment provider server 230 corresponding generally to user device 110 and payment provider server 130, respectively, of FIG. 1.

User device 210 of FIG. 2B displays a payment provider application interface 220b to a user (not shown) of user device 210. Payment provider application interface 220b may correspond to an interface displaying similar executed processes and procedures of payment provider application 120 of FIG. 1. In this regard, payment provider application interface 220b displays an account resolution center 222 and navigation 226 to the user. Account resolution center 222 may further display a selected account notification from the account notifications received from payment provider server 230. Thus, account resolution center 222 displays the selected account notification being operated on by the user. In other embodiments, the user may have selected the account notification to take another action with respect to the user account corresponding to the account notification.

Since the user of user device 210 in environment 200a of FIG. 2A has selected notification 264, environment 200b of FIG. 2B shows notification 264 under account resolution center 222 of payment provider application interface 220b. After selection of notification 264, the user is shown a request 266, a completion amount 270, a status 272, required information 274, and required information 276. Request 266 may correspond to request 266 from FIG. 2A and displays the request for information from notification 264. Further completion amount 270 displays the amount and/or number of tasks submitted by the user to complete request 266. As shown in FIG. 2B, the user has completed 0 of 2 tasks. Completion amount 270 may also display a percentage or bar display showing the amount the user has completed of request 266.

Status 272 may correspond to a status of an information submission for request 266. For example, if proof of identify is required in request 266, status 272 may display whether the proof of identity submitted by the user of user device 210 has been accepted by payment provider server 230. If payment provider server 230 is still processing the proof of identity, status 272 may alert the user that the proof of identity is still processing. Thus, as the user selects one of required information 274 and required information 276, the user may begin submitting the information required to complete request 266. Required information 274 corresponds to a request to update the user's person information, while required information 176 includes a request to submit proof of identity. Once the user has completed and submitted the information required in required information 274 and 276, status 272 may update the user of the status of the submissions, and completion amount 270 may change to reflect that one or more of required information 274 and required information 276 are completed. Payment provider server 230 may receive the information submissions by the user for processing and store the information with account 252 as user information 256. Thus, pending and verified information for the user may be included in user information 256. The user may also use navigation 226 to navigate between notifications and required information and/or alerts in the notifications.

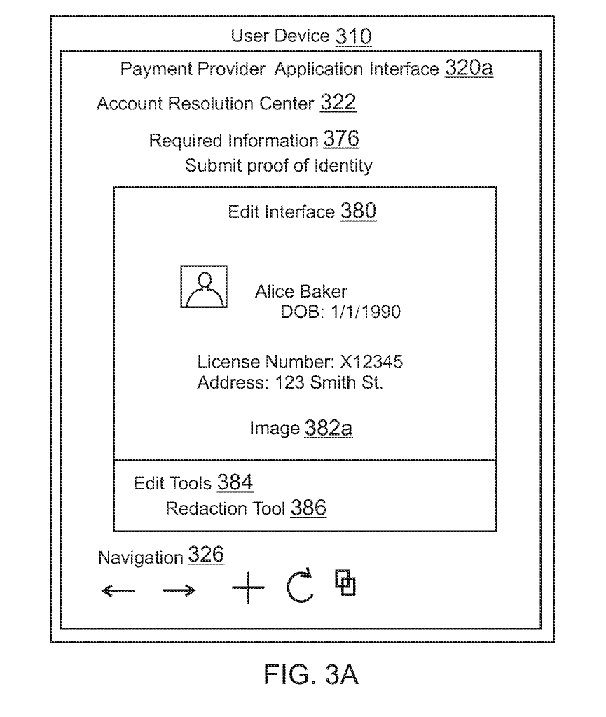

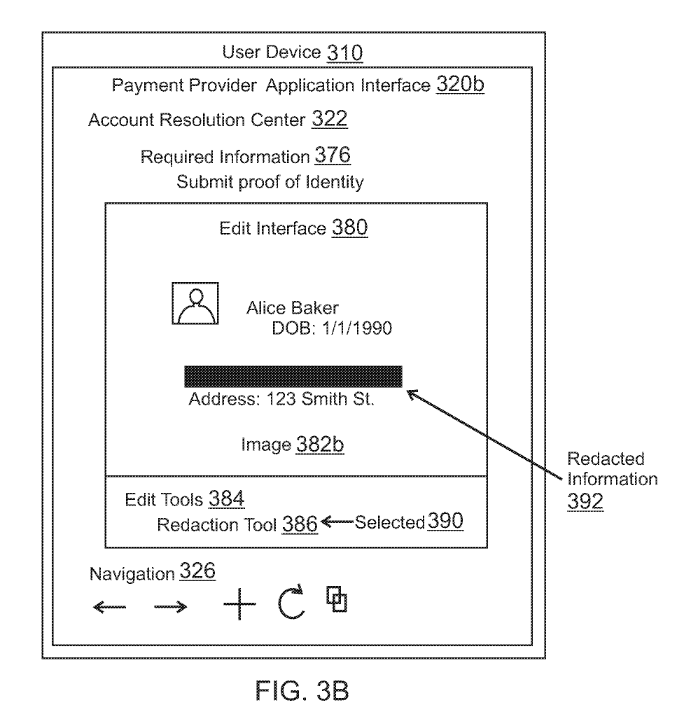

FIG. 3A is an exemplary user device displaying user information utilized to complete a request for user information in an account notification, according to an embodiment. FIG. 3A includes a user device 310 corresponding generally to user device 110 of FIG. 1. Additionally, user device 310 displays a payment provider application interface 320a, which may correspond to an interface displaying similar executed processes and procedures of payment provider application 120 of FIG. 1.

Payment provider application interface 320a includes an account resolution center 322. Account resolution center 322 may correspond to a similar page, window, or feature of an application displaying payment provider application interface 320a as account resolution center 222 for FIGS. 2A and 2B. Thus, account resolution center 322 corresponds to a feature enabling a user (not shown) of user device 310 to resolve account notifications received from a payment provider (not shown). Account resolution center 322 includes required information 376 and navigation 326. Required information 376 may correspond to required information in a request for information for an account notification. Thus, required information 376 may correspond to required information 276 in FIG. 2B. Navigation 326 may allow the user to navigate between interfaces, such as navigation to another part of account resolution center 322 (e.g., another account notification).

Required information 376 request that the user of user device 310 submits proof of identification. As previously discussed, proof of identification may be a driver license, passport, birth certificate, social security card, or other form of identification. In FIG. 3A, the user either captured or imported an image including the user's driver license. Thus, edit interface 380 includes image 382a having the image of the driver license. Edit interface 380 may correspond to a tool that enables the user to edit image 382a. Editing of image 382a may include resizing, cropping, color adjustment, saturation and/or contrast adjustment, etc. Thus, edit interface 380 includes edit tools 384. Edit tools 384 may include tools, menus, options, etc., that enable the user to edit image 382a. Additionally, edit tools 384 includes redaction tool 386. Redaction tool 386 may include a tool to omit and/or black/white out a portion of image 382a. Thus, if the user wishes to omit sensitive information, the user may utilize redaction tool 386 to omit the information.

FIG. 3B is an exemplary user device submitting redacted user information utilized to complete a request for user information in an account notification, according to an embodiment. FIG. 3A includes a user device 310 corresponding generally to user device 110 of FIG. 1. Additionally, user device 310 displays a payment provider application interface 320b may correspond to an interface displaying similar executed processes and procedures of payment provider application 120 of FIG. 1.

Payment provider application interface 320b displays image 382b after redaction using redaction tool 386. Thus, as shown in FIG. 3B, redaction tool 386 is highlighted with selected 390. After choosing redaction tool 386, selected 390 may appear to inform the user of user device 310 that redaction tool 286 is select. A cursor or other input tool may appear on payment provider application interface 320b. Use of the tool with image 382b may enable the user to redact information. Thus, as shown in FIG. 3B, redacted information 392 shows a black out of the user's driver license number.

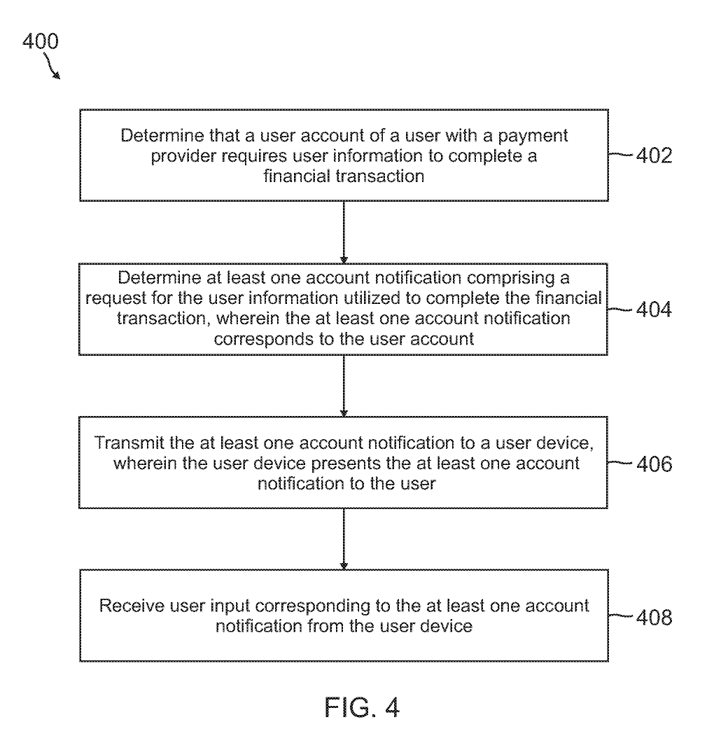

FIG. 4 is a flowchart of an exemplary process for account notifications for required information to complete a financial transaction. Note that one or more steps, processes, and methods described herein may be omitted, performed in a different sequence, or combined as desired or appropriate.

At step 402, a user account of a user is determined to require user information to complete a financial transaction. User information may include personal, financial, or other information. Additionally, the user information may correspond to a request for proof of identity or to confirm the financial transaction. For example, the financial transaction may correspond to a large transfer where the user information required is confirmation that the user authorized the transaction.

At least one account notification comprising a request for the user information utilized to complete the financial transaction is determined, at step 404, wherein the at least one account notification corresponds to the user account of the user. The at least one account notification may further comprise one of a first alert corresponding to withdrawn funds in the user account and a second alert corresponding to deposited funds in the user account. At step 406, the at least one account notification is transmitted to a user device, wherein the user device presents the at least one account notification to the user. A user may view the account notification and enter user input corresponding to the account notification. For example, where the account notification corresponds to a request for information, the user may complete the request for information. In other embodiments, the user may approve a money withdrawal/transfer, or perform some other action.

At step 408, user input corresponding to the at least one account notification is received. The user input may correspond to a request for information, where the request for information may be completed with the user input. For example, personal/financial information corresponding to the user may be requested, where the user must enter and/or upload the financial information. The user input may also comprise one of a request to place a hold on a financial resource corresponding to the user account, an authorization to transfer a monetary amount, and an authorization to withdraw a monetary amount.

After receiving the user input, the request for user information may be completed using the user input. After receiving the user input, a completion update corresponding to the request for information may be transmitted to the user device, wherein the completion update comprises additional required information for the request for user information. The completion update may comprise a percent complete of the request for user information, a bar showing a completion amount of the request for information, a number of requests for information completed, etc. Additionally, while processing/completing the request for information, a status update corresponding to completion of the request for the user information may be transmitted to the user device, wherein the status update comprises an expected time to verification of the completion of the request for the user information.

In various embodiments, an image may be required to be submitted in the request for information. Thus, the user input may correspond to an image and the user device may provide an edit interface having edit tools and the image. One of the edit tools may be a sensitive information redaction tool, where the user may redact sensitive information on the image using the sensitive information redaction tool. The image may therefore be utilized to verify an identity of the user, for example, if the image comprises a representation of one of a driver license, passport, birth certificate, social security card, and bank statement.

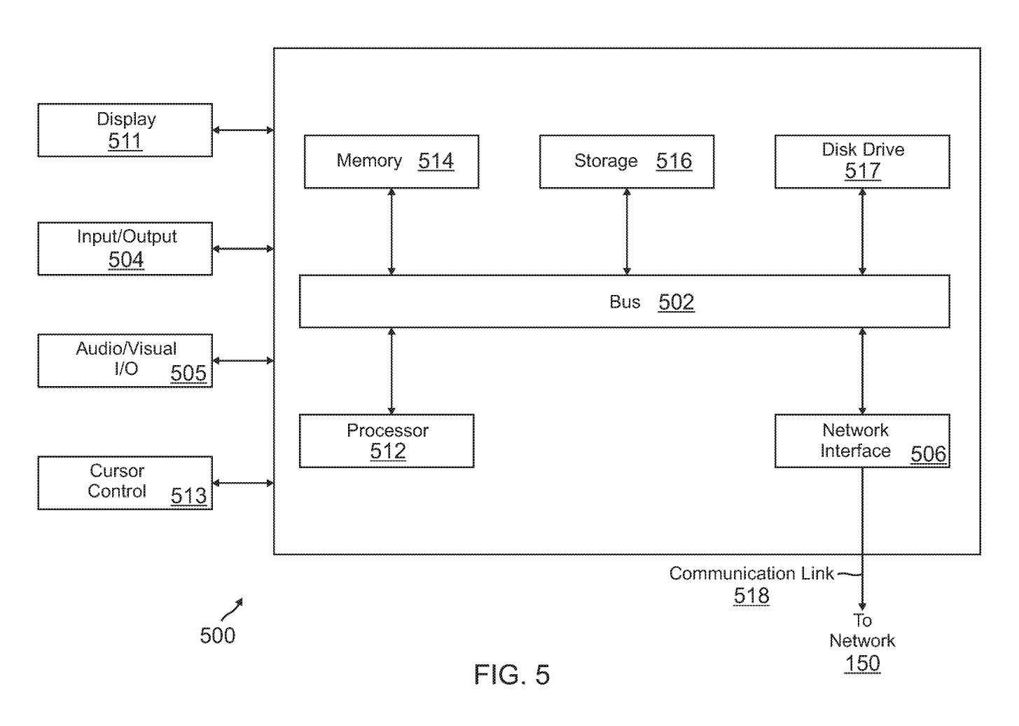

FIG. 5 is a block diagram of a computer system suitable for implementing one or more components in FIG. 1, according to an embodiment. In various embodiments, the user device may comprise a personal computing device (e.g., smart phone, a computing tablet, a personal computer, laptop, PDA, Bluetooth device, key FOB, badge, etc.) capable of communicating with the network. The merchant device and/or service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, a merchant device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
determining that a user account at a payment provider requires user information to validate the user account, the user account associated with a user;
generating a request for the user information;
causing to be displayed, in a graphical user interface (GUI) of an application executing on a user device associated with the user, the request in the GUI of the user device, wherein the GUI includes at least one data input field associated with the user information;
in response to a selection of the request in the GUI, receiving user input associated with the user information through the at least one data input field of the GUI;
validating the user input using stored information for the user account with the payment provider;
determining, based on the validating, a completion percentage indicating additional required user information and an adverse action affecting the user account based on non-entry of the additional required user information; and
causing to be displayed, through the GUI, the completion percentage as a visual presentation and the adverse action.

2. The system of claim 1, wherein the determining that the user account requires the user information comprises determining that a current network address of the user device at the time of a transaction is different than a stored network address for the user device in the stored information.

3. The system of claim 1, wherein the validating the user input comprises comparing the user input to the stored information to determine a likelihood of fraud.

4. The system of claim 1, wherein the operations further comprise:
determining that the user input matches the user information; and
authorizing the user for use of the account.

5. The system of claim 1, wherein the operations further comprise:
transmitting a status update corresponding to a completion of the request, wherein the status update comprises an expected time to verification of the user input for the user information.

6. The system of claim 1, wherein the user information comprises information required to validate or maintain a user account based on a risk and compliance model associated with the user account.

7. The system of claim 1, wherein the request further comprises one of a first alert corresponding to withdrawn funds in the user account or a second alert corresponding to deposited funds in the user account.

8. The system of claim 1, wherein the user input comprises one of a request to place a hold on a financial resource corresponding to the user account, an authorization to transfer a monetary amount, or an authorization to withdraw a monetary amount.

9. A method comprising:
determining that a user account at a payment provider requires user information to validate the user account, the user account associated with a user;
generating a request for the user information;
causing to be displayed, in a graphical user interface (GUI) of an application executing on a user device associated with the user, the request in the GUI of the user device, wherein the GUI includes at least one data input field associated with the user information;
in response to a selection of the request in the GUI, receiving user input associated with the user information through the at least one data input field of the GUI;
validating the user input using stored information for the user account with the payment provider;
determining, based on the validating, a completion percentage indicating additional required user information and an adverse action affecting the user account based on non-entry of the additional required user information; and
causing to be displayed, through the GUI, the completion percentage as a visual presentation and the adverse action.

10. The method of claim 9, wherein the determining that the user account requires the user information comprises determining that a current network address of the user device at the time of a transaction is different than a stored network address for the user device in the stored information.

11. The method of claim 9, further comprising:
determining that the user input matches the user information; and
authorizing the user for use of the account.

12. The method of claim 9, further comprising:
transmitting a status update corresponding to a completion of the request, wherein the status update comprises an expected time to verification of the user input for the user information.

13. The method of claim 9, further comprising:
wherein the user information comprises information required to validate or maintain a user account based on a risk and compliance model associated with the user account.

14. The method of claim 9, wherein the user input comprises an image, wherein the user device provides the user with an edit interface including an edit tool for the image.

15. The method of claim 14, wherein the edit tool includes a sensitive information redaction tool, and wherein the user input comprises redacted information on the image using the sensitive information redaction tool.

16. A non-transitory machine-readable medium having stored thereon machine-readable instructions executable to cause a computer to perform operations comprising:
determining that a user account at a payment provider requires user information to validate the user account, the user account associated with a user;
generating a request for the user information;
causing to be displayed, in a graphical user interface (GUI) of an application executing on a user device associated with the user, the request in the GUI of the user device, wherein the GUI includes at least one data input field associated with the user information;
in response to a selection of the request in the GUI, receiving user input associated with the user information through the at least one data input field of the GUI;
validating the user input using stored information for the user account with the payment provider;
determining, based on the validating, a completion percentage indicating additional required user information and an adverse action affecting the user account based on non-entry of the additional required user information; and
causing to be displayed, through the GUI, the completion percentage as a visual presentation and the adverse action.

17. The non-transitory machine-readable medium of claim 16, wherein the determining that the user account requires the user information comprises determining that a current network address of the user device at the time of a transaction is different than a stored network address for the user device in the stored information.

18. The non-transitory machine-readable medium of claim 16, wherein the operations further comprise:
determining that the user input matches the user information; and
authorizing the user for use of the account.

19. The non-transitory machine-readable medium of claim 16, wherein the user input comprises an image used to verify an identity of the user.

20. The non-transitory machine-readable medium of claim 19, wherein the image comprises a representation of one of a driver license, a passport, a birth certificate, a social security card, or a bank statement.
